(19) United States
(12) Patent Application Publication
(10) Pub. No.: US 2026/0149106 A1
(43) Pub. Date: May 28, 2026

(54) BATTERY SUPPORT ARRANGEMENT WITH A SUPPORT

(71) Applicant: BENTELER AUTOMOBILTECHNIK GMBH, Paderborn (DE)

(72) Inventors: Christian HANDING, Langenberg (DE); Kai MICHEL, Salzkotten (DE); Stefan SCHMITZ, Bielefeld (DE)

(21) Appl. No.: 19/389,024

(22) Filed: Nov. 14, 2025

(30) Foreign Application Priority Data
Nov. 25, 2024 (EP) 24215205.6

(51) Int. Cl. H01M 50/264; H01M 50/224; H01M 50/24; H01M 50/249

(52) U.S. Cl. CPC H01M 50/264; H01M 50/224; H01M 50/24; H01M 50/249

(57) ABSTRACT

A battery support arrangement includes a battery tray made of metallic material, with a base and a side wall surrounding the base. The batteries are arranged in the battery tray and at least one support is arranged in the battery tray as a cross member or longitudinal member, which is made of a steel material, and the support is designed in cross section as a hollow profile, which is open on one side in its cross section, having a web and legs extending from the web. The web and partly the legs are cut out in longitudinal sections and a clasp is inserted in some regions in the cutout, which clasp is mounted at a height offset with respect to the web.

### RELATED APPLICATIONS

The present application claims priority of European Application Number 24215205.6 filed Nov. 25, 2024, the disclosure of which is hereby incorporated by reference herein in its entirety.

### FIELD

The present disclosure relates to a battery support arrangement.

### BACKGROUND

Battery supports that are installed in the underfloor of a motor vehicle are known from other references. For this purpose, a vehicle is able to, for example, be powered entirely electrically or, as a so-called hybrid vehicle, the electrical part of the drive energy, which is generated, for example, by an internal combustion engine, is able to be stored.

Such battery support arrangements are sufficiently known from the other references. For example, from DE 10 2017 109 722 A1 or DE 10 2020 107 635 A1. The battery supports are characterized by a battery tray made of metallic material. The battery tray is able to be manufactured, for example, as a formed component or as a folded component from a sheet metal blank. Steel materials or light metal materials are used for this purpose. Such a battery tray is able to also be constructed with a flat base plate with a surrounding frame structure.

The battery tray is able to be closed with a lid or a hood. Batteries, which are also able to be referred to as drive batteries or electrical energy storage modules, are then arranged inside the battery tray. The batteries themselves are smaller in area than the battery tray itself. Therefore, the batteries are fastened inside the battery tray. For this purpose, fastening points are provided inside the battery tray.

In order for the battery tray to have both receptacles for fastening batteries, but also a certain inherent rigidity and crash safety, the other references describe that cross members and/or longitudinal members are arranged within the battery tray.

The object of the present disclosure is, based on the other references, to provide a battery support which, while being inexpensive to manufacture, has an optimized interior for accommodating batteries as well as the corresponding wiring and electronics, while at the same time providing improved crash performance.

The aforementioned object is achieved by a battery support arrangement.

The battery support arrangement has a battery tray made of a metallic material, for example, steel. The battery tray has a base and a side wall surrounding the base. Consequently, side walls rise from the base and project upwards relative to the base in relation to the vertical direction of the vehicle. In at least some embodiments, the battery tray is able to be closed with a lid or a hood. In at least some embodiments, an external circumferential flange is provided at the upper end of a side wall.

Batteries, which are also able to be referred to as drive battery trays, are then arranged in the battery tray itself.

In at least some embodiments, the battery tray is manufactured as a one-piece sheet metal tray made from the same material, which is done, for example, through a deep drawing process.

In at least some embodiments, the battery tray is made of a steel alloy. The battery tray is able to, for example, in response to being made of a steel alloy, be manufactured, for example, as a hot-formed and press-hardened component. In at least some embodiments, the battery tray is also able to be made from a tailored blank, for example a tailored welded blank or a tailored rolled blank, and is able to be hot-formed and press-hardened, at least in some regions. For example, in response to the battery tray being made of steel as a hot-formed and a press-hardened component, it has a tensile strength Rm>980 MPa. In at least some embodiments, the battery tray is also able to be made of zinc- or aluminum-silicon-coated sheet steel. In at least some embodiments, a corrosion protection coating, for example, cathodic dip coating, is able to be applied at least on the outside or on the underside of the tray.

At least one support is arranged in the battery tray. The support is designed as a cross member and/or as a longitudinal member. The support itself is made of a steel material. For example, the support is manufactured as a formed component, for example, a sheet metal formed component, from the steel material. For this purpose, according to the disclosure, the support is designed in cross section as a hollow profile which is open on one side and has a web and legs extending from the web. The web and partially the legs are cut out in longitudinal sections. According to the disclosure, a clasp is inserted in the cutout in some regions, wherein the clasp, for example, a clasp web or a bearing surface of the clasp, is mounted at a height offset relative to the web of the support.

Manufacturing the support as a sheet steel component is enabled according to the disclosure, which results in a low dead weight and at the same time high rigidity. This brings manufacturing advantages, as a sheet steel component is sometimes easier to machine than a component made of a light metal alloy. Furthermore, the use of steel material provides weight advantages while at the same time increasing rigidity. Less material is required and the weight is reduced, while at the same time the rigidity of the support remains at least the same or is even increased. To overcome a possible disadvantage with regard to possible connection points which is able to be placed differently and individually on or in the support, at least one clasp is inserted in the support according to the disclosure. Multiple clasps are also able to be inserted along the length of the support. This enables providing different, individually coordinated connection points in a steel support in a simple and cost-effective manner using at least one clasp or multiple clasps.

The support itself is, for example, U-shaped or hat-shaped in cross-section. The clasp itself is also able to be designed as a profile component, wherein, in at least some embodiments, the clasp is then also U-shaped in cross section. For this purpose, the clasp has a clasp web and clasp legs extending from the clasp web. The purpose of the disclosure is the height offset, then formed between the web of the support and the clasp web of the clasp. In relation to the vertical direction of the vehicle, the clasp is, for example, offset downwards relative to the web, so that the clasp provides a still lower connection point in the support itself.

The clasp itself is coupled to the support, for example, by thermal joining. However, another coupling method, such as riveting or even an adhesive method, is also able to be used. Thus, the support is initially manufactured as a sheet metal formed component from a steel alloy. The support itself is also able to be hot-formed and press-hardened. In at least some embodiments, the support has a cutout made beforehand so that the web is cut out in longitudinal sections and the webs are cut out at least in regions or partially.

However, the support is also able to be cut out after sheet metal forming, for example by a laser cutting process.

In at least some embodiments, the clasp itself has a wall thickness that is greater than the wall thickness of the support. This offers the advantage that the clasp has a high level of inherent rigidity. At the same time, however, it is possible for at least the clasp web to have a greater wall thickness and thus, for example, a thread is able to be cut directly into the wall of the clasp web, so that a screwing point is created directly, without the additional use of weld-in or screw-in nuts.

The clasp therefore has at least one fastening element. The fastening element can be, for example, a weld-in or screw-in nut. However, the fastening element is also able to be a thread cut directly into the wall of the clasp. In at least some embodiments, the clasp itself is also able to have a raised surface or bearing surface, which is in turn offset in height from the tensioning web. In at least some embodiments, the bearing surface is positioned higher than the tensioning web itself in relation to the vertical direction of the vehicle.

In at least some embodiments, fastening elements are also arranged in the web of the support itself. These are able to be, for example, weld-in or screw-in nuts, which are then arranged in the web. The fastening element in the clasp allows for individual positioning of additional fastening points.

Furthermore, in at least some embodiments, the legs of the support have a recess in the region of the clasp. In the sense of the disclosure, this means that the legs are shaped inwards in the region of the clasp. Thus, the regions of the legs are formed in relation to the cross-section of the support as pointing towards each other. The legs of the clasp then engage over the recess on the outside. A key advantage of the disclosure is that the support itself does not have an increased width in the region of the clasp. This optimizes the installation space inside the battery support, while at the same time allowing individual positioning of screw points on the support itself.

In order for the support to be arranged in the battery tray, in at least some embodiment, the support is hat-shaped. In at least some embodiments, the legs of the support rest on the base and are glued or spot-welded. In at least some embodiments, at its respective outer end faces, the support is able to furthermore rest against an inner side of the respective side wall and is also able to be joined here.

In at least some embodiments, the web of the support is oriented parallel to the base of the battery support. In at least some embodiments, the clasp web runs parallel to the base of the battery support. However, the connection points in the region of the clasp are able to be individually set in such a way that the clasp is arranged at an angle relative to the longitudinal extent of the support. This would allow the clasp web to be positioned at any angle relative to the base of the battery tray, so that the fastening point is positioned at an individual angle.

### BRIEF DESCRIPTION OF THE DRAWING

Aspects of the present disclosure are best understood from the following detailed description when read with the accompanying figures.

FIG. 1 shows a battery tray of a battery support in plan view, according to at least some embodiments of the subject disclosure.

FIG. 2 shows a battery tray of a battery support in plan view, according to at least some embodiments of the subject disclosure.

FIG. 3 shows a support in perspective view, according to at least some embodiments of the subject disclosure.

FIGS. 4a, b, c show side views, top views and cross-sectional view of the support in a first embodiment variant, according to at least some embodiments of the subject disclosure.

FIGS. 5a, b, c show an alternative design variant to FIG. 4, according to at least some embodiments of the subject disclosure.

FIG. 6 shows an alternative embodiment of the support, according to at least some embodiments of the subject disclosure.

FIG. 7 shows a cross-sectional view from FIG. 6, according to at least some embodiments of the subject disclosure.

### DETAILED DESCRIPTION

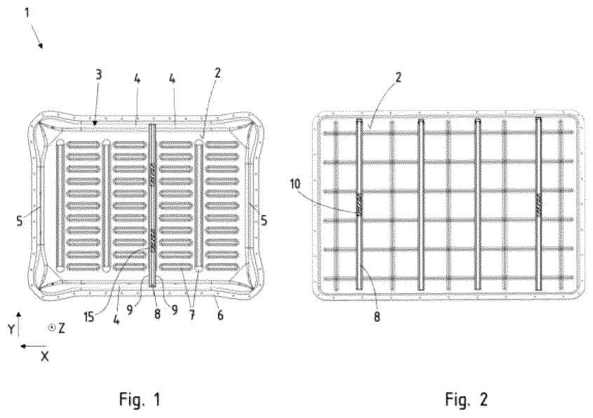

FIGS. 1 and 2 show a respective battery tray of a battery support in plan view.

The battery tray 1 has a base 2. A side wall 3 is formed all around the sides. These are designed as a transverse side wall 5 in the vehicle X direction and as a longitudinal side wall in the vehicle Y direction. Pointing to the viewer relative to the image plane, the walls are also arranged in the vehicle vertical direction Z. A flange 6 is provided around the outside, to which a cover or hood (not shown in detail) is coupled, so that an interior space for accommodating batteries, not shown in detail, is created within the battery tray 1. Longitudinal and transverse beads 7 are also able to be embedded in the base 2, which serve, for example, for stiffening and/or for the formation of cooling channel structures.

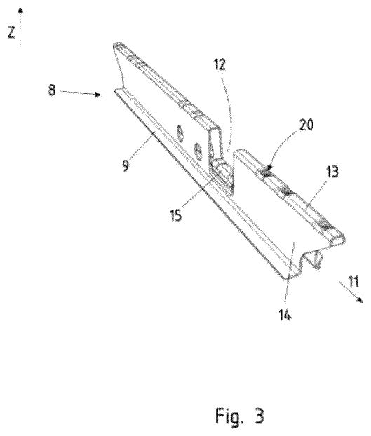

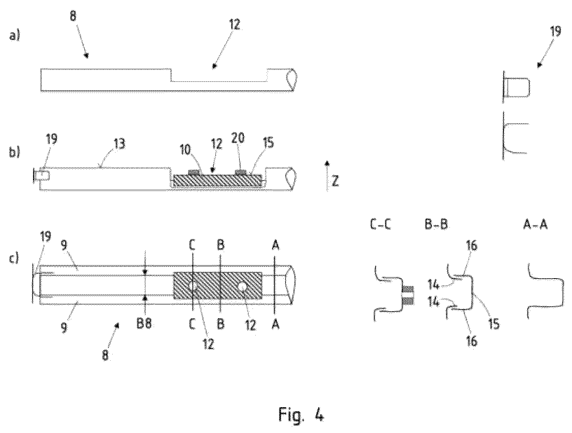

According to the disclosure, a respective support 8 is inserted in the form of a cross member. The cross member is placed on the base 2 and has to this end a flange 9 with a hat-shaped profile, with which it is also coupled to the base 2. A clasp 10 is inserted into the support 8 in longitudinal sections, which clasp is described below in FIG. 3.

The support 8 is shown as an elongated component and has a U-shaped or hat-shaped contour in cross-section. Deviating from FIG. 3, the flanges 9 are also able to be formed only in longitudinal sections in order to form local coupling tabs to the base 2. In the longitudinal direction of the support 8, the support is cut out in lengthwise sections or has a cutout. According to the disclosure, a clasp 10 is inserted into this cutout. The support 8 itself has a web 13 and legs 14 extending from the web 13. The legs 14 are essentially oriented in the vertical direction Z of the motor vehicle in the installed position. The web 13 is arranged oriented essentially parallel to a plane spanned by the vehicle longitudinal direction X and vehicle transverse direction Y. The clasp 10 is thus offset in height relative to the web 13. The clasp 10 is offset downwards relative to the web 13, for example, with respect to the motor vehicle vertical direction Z.

The web 13 of the support 8 is able to have fastening elements 20, which are formed here locally lowered and thus positioned flush with the plane of the web 13 on the upper side.

FIGS. 4a, b, and c show the structure of such a support 8. Here, according to FIG. 4a, a longitudinal section of a support 8 is shown, which has the cutout. In cross-section, the support 8 has a web 13 and legs 14 extending from the web 13. From the legs 14, in turn, protrude the flanges 9, with which the support 8 rests on the base 2.

According to FIG. 4b, the clasp 10 is then positioned in the cutout 12. The clasp 10 itself is designed as a U-shaped component in cross-section. For this purpose, the clasp 10 has a clasp web 15 and clasp legs 16 extending from the clasp web 15. The clasp legs 16 rest against the legs 14 of the support 8 and are joined to them. Furthermore, the clasp web 15 itself forms a bearing surface with which, for example, the clasp 10 is offset in height relative to the web 13 with respect to the motor vehicle vertical direction Z. Here, fastening points are able to be arranged, which for example are able to be raised relative to the clasp web 15 or are able to be offset upwards relative to it.

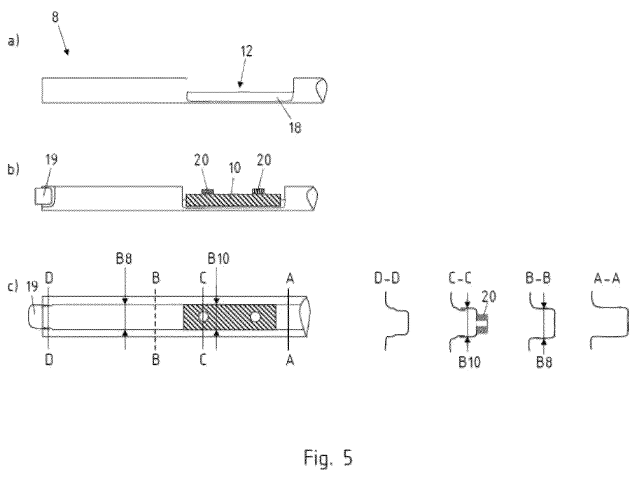

FIGS. 5a, b and c show an alternative design variant to FIG. 4. Here, the legs 14 of the support 8 are formed inwards in the region of the cutout. The clasp 10 thus has the same width B10 as the width B8 of the support 8 itself. The space available in the interior of the battery support is thereby optimized, for example, the batteries are able to lie flush laterally against the legs 14 of the support 8. Thus, according to the plan view of FIG. 5c, a continuous contact surface is able to be achieved on the sides of the legs 14, since the legs 14 of the support 8, but also the clasp legs 16, have the same width.

In addition, FIGS. 4 and 5 show various internal connections of the support 8 to the side wall 3 of the battery tray 1.

In the image plane of FIG. 4 on the right, a coupling component 19 for connecting one end of the support 8 to the inside of the side wall of the battery tray is shown, above in an enlarged side view and below in a plan view. According to FIGS. 4b and 4c, the coupling component 19 is then coupled to the support 8. The inner wall of the battery is not shown in detail. The back of the coupling component 19 is then connected to the inner wall of the battery tray 1.

The same applies to FIGS. 5b and c. Here, similarly, a coupling component 19 in the form of a clasp 10 is shown. According to FIGS. 5b and c, this is then able to be coupled to the legs 14 of the support, so that the overall width B8 of the support 8 results. Thus, the legs 14 are pressed inwards to connect the coupling component 19. The coupling component 19 itself then also has the width B8 of the support. Here, too, installation space optimization is carried out.

Furthermore, FIGS. 4c and 5c show, on the right, different sectional views relative to the image plane.

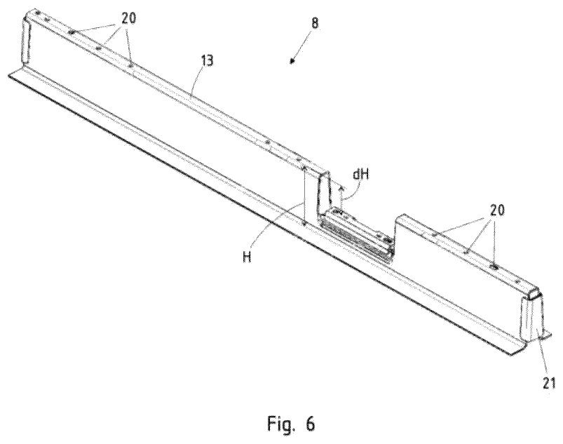

FIG. 6 shows an alternative embodiment of the support 8. Compared to the embodiment of FIG. 3, the support 8 now has several non-lowered fastening elements 20 which protrude beyond the plane of the web 8. For example, nuts, for example, weld-in nuts, are able to be attached to the web 13 from below. In addition, the ends of the support 8 are partially closed and form a flat, larger side impact surface 21 compared to FIG. 3. This ensures that a piercing or cutting of the side wall 3 of the battery tray in the event of a crash-related deformation of the battery tray 1 and a critical deformation level of the battery tray 1 into the battery compartment is able to be avoided. The side impact surface 21 is formed, for example, by a tab attached to the end of the support 8.

The side impact surface 21 is provided here by a sheet metal part additionally joined to one (or both) leg(s) 14, but is also able to be formed integrally by folding or bending the front ends of the support 8. The side impact surface 21 is able to rest against the side wall 3 of the battery tray 1 without a gap, in at least some embodiments, the side impact surface 21 and the side wall 3 are spaced a few millimeters or centimeters apart.

In the examples in both FIG. 3 and FIG. 6, the height offset dH between the clasp web 15 and the web 13 of the support 8 is able to be seen, which in each case amounts to at most 90% of the support height H, for example, between 10% and 85%, or between 20% and 75% of the height H of the support. This increases the buckling stiffness of the support, especially in the event of a side impact. At the same time, the clasp length L10 corresponds approximately to the length L12 of the cutout 12 of the support 8, which also contributes to the buckling stability.

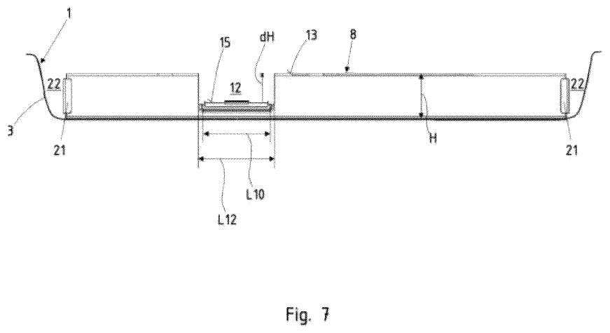

Finally, FIG. 7 shows a cross-sectional view through the battery tray 1 with the support 8 from FIG. 6 in the installed position. The gap distance 22 resulting from the (deep-drawing-related) inclined side wall 3 and the vertical front end of the support is able to be seen, which avoids production-related tolerance problems or coupling components as in FIG. 3.

1. A battery support arrangement, comprising:
a battery tray made of steel material, with a base and a side wall surrounding the base, wherein
batteries are arrangeable in the battery tray,
at least one support is arranged in the battery tray as a cross member or a longitudinal member,
the at least one support is made of a steel material,
the at least one support is configured in cross section as a U-shaped or hat-shaped press-formed component, having a web and legs extending from the web,
a longitudinal section of the at least one support has a cutout in which the web and partly the legs are cut out, and
a clasp is inserted in the cutout, and is mounted at a height offset with respect to the web.

2. The battery support arrangement according to claim 1, wherein the clasp is a profile component, and the clasp has a clasp web and clasp legs extending therefrom.

3. The battery support arrangement according to claim 1, wherein the clasp is coupled to the at least one support by thermal joining.

4. The battery support arrangement according to claim 1, wherein the clasp comprises at least one threaded fastening element.

5. The battery support arrangement according to claim 2, wherein the clasp has a raised surface at a height offset from the clasp web.

6. The battery support arrangement according to claim 1, further comprising fastening elements in the web.

7. The battery support arrangement according to claim 2, wherein the legs have recesses in a region of the clasp, and the recesses extend over a length which corresponds to at least one of a length of the cutout or a length of the clasp.

8. The battery support arrangement according to claim 7, wherein the legs are formed inwards in the region of the clasp in such a way that the clasp legs are received in the recesses.

9. The battery support arrangement according to claim 1, wherein the support is coupled to the base.

10. The battery support arrangement according to claim 1, wherein
the support rests has an end face resting on an inner side of the side wall, or
the support is fastened to the inner side of the side wall in a materially bonded or a force-fitting manner via a tolerance-compensating sliding fit.

11. The battery support arrangement according to claim 1, wherein
the support is hat-shaped in at least one longitudinal section with flanges adjoining the legs, and
the flanges extend at an angle away from the legs and are joined in a materially bonded manner to the base.

12. The battery support arrangement according to claim 1, wherein the support has an end face resting on and coupled to an inner side of the side wall.
